(19) United States
(12) Patent Application Publication
(10) Pub. No.: US 2007/0181624 A1
(43) Pub. Date: Aug. 9, 2007

(54) Apparatus for retention and storage of removable vehicle doors

(76) Inventor: Dwight David Smith, Bedford, VA (US)

Correspondence Address: Dwight D. Smith, 1933 Twin Lake Drive, Bedford, VA, 24523, US

(21) Appl. No.: 11/350,207

(22) Filed: Feb. 8, 2006

(51) Int. Cl. B60R 11/00; B60R 9/00

(52) U.S. Cl. 224/519; 224/497; 224/533

(57) ABSTRACT

An apparatus for retention and storage of removable vehicle doors can easily be inserted into a vehicle tow hitch receiver as an aftermarket accessory. The apparatus includes a tubular structure configured so that it can fold for storage, and is easily installed and removed from the vehicle tow hitch receiver. The apparatus is configured with adjustable brackets so removable doors from different like vehicles can be accommodated. The apparatus is most desirable when an operator removes the removable doors and desires a safe method to store them while traveling. This device protects the doors from physical damage, and frees the interior space of the vehicle for other purposes.

### CROSS-REFERENCE TO RELATED APPLICATION

NOT APPLICABLE

### STATEMENT REGARDING FEDERALLY SPONSORED RESEARCH OR DEVELOPMENT

NOT APPLICABLE

### BACKGROUND OF THE INVENTION

Operators of vehicles with removable doors have little space in the vehicle to store the doors while removed and traveling. Many of these vehicles have a trailer tow hitch that can be used to connect an apparatus for retaining and storing the doors while removed and traveling. This device could be stored in a folded position either in the vehicle tow hitch, or behind the rear seat of the vehicle. When the operator wishes to remove either the upper half, or both halves of combination doors, or the whole door of hard windowed doors, they can insert the apparatus into the vehicle tow hitch receiver, unfold it to the upright position, and safely store the removable doors. This device would protect the removable doors from physical damage, and free the interior space of the vehicle for other purposes.

### OBJECTS AND SUMMARY OF THE INVENTION

It is the principle object of the present invention to provide an apparatus for retention and storage of removable vehicle doors that can easily be inserted into a vehicle tow hitch receiver as an aftermarket accessory.

It is also a principle object of the present invention that the apparatus be easily removed from the vehicle tow hitch receiver.

It is a further principle object of the present invention that it can be stored either in the vehicle tow hitch receiver or behind the rear seat of the vehicle.

It is another principle object of the present invention that it has a mechanism to stabilize it in the vehicle tow hitch receiver.

It is yet another principle object of the present invention that it folds into a low profile position while inserted into the vehicle tow hitch receiver.

It is yet another principle object of the present invention that when removed from the vehicle tow hitch receiver it can be folded into a low profile position for storage behind the vehicles rear seat.

It is yet another principle object of the present invention that it retains and stores the removable upper and lower doors of combination type doors.

It is a still further principle object of the present invention that it retains and stores the removable hard windowed type doors.

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims.

To achieve the objects and in accordance with the purpose of the invention, as embodied and broadly described herein, an apparatus for retention and storage of removable vehicle doors that can be easily inserted into a vehicle tow hitch receiver as an aftermarket accessory, is comprised of four basic components. A tubular bar is configured so that it can be inserted and retained in a vehicle tow hitch receiver with a standard clevis pin (the hitch bar). The opposing end of the hitch bar is connected in a tee fashion to another horizontal tubular bar (the cross bar). At one end of the cross bar is a tubular bar attached at an approximate vertical right-angle (the hinge post). At the opposing end of the cross bar is another tubular bar attached at an approximate vertical right-angle (the latch post). The hinge post and latch post retain either both halves of combination doors, or the whole door of hard windowed doors, by using their hinges, pins or latch points. The hinge post and cross bar retain the upper half of combination doors when they are the only parts of the removable doors that have been removed from the vehicle.

The hitch bar houses a mechanism that stabilizes the apparatus in the vehicle tow hitch receiver. Using the standard clevis pin mount as a pivot point, a threaded knob can be tightened and as a result a clamping force is applied within the vehicle tow hitch receiver.

The apparatus is configured such that it can be easily removed for storage away from the vehicle or behind the vehicles rear seat by removing the standard clevis pin holding it in the vehicle tow hitch receiver. Using selected pivot points, the hinge post, and latch post can be folded down in alignment with the cross bar. With yet another pivot point, the hitch bar can also be folded in alignment with the cross bar when the apparatus is removed from the vehicle tow hitch receiver.

Each tubular component is held to its adjoining tubular component by plates that allow the joints to pivot. The plates form a sandwich with the tubular component in the middle, and are thru bolted to secure them and form a pivot point for folding purposes. Each pivoting joint is equipped with an easily removable pin so the joint can be manipulated and secured in either the upright or folded down position. The pivot joints are protected by shims between the plates and the tubular components to reduce friction and protect the surface finish.

The hinge post is equipped with adjustable brackets that receive the hinge pins of the removable doors. Each bracket has slots to assure adjustability, and each bracket is equipped with plastic bushings to protect the door pins and painted surfaces of the removable doors. The upper hinge bracket is adjustable to conform to the different hinge positions likely found from each different vehicle.

The latch post is quipped with a bracket that receives the latch mechanism of the removable doors. This bracket has slots to assure adjustability, and each bracket is quipped with adjustable “U” shaped bolts to accommodate the different latch positions likely found from each different vehicle.

The accompanying drawings, which are incorporated in and constitute a part of this specification, illustrate at least one presently preferred embodiment of the invention. These drawings, together with the description, serve to explain the principles of the invention but by no means are intended to be exhaustive of all of the possible manifestations of the invention.

### BRIEF DESCRIPTION OF THE DRAWINGS

FIG. 1 is a perspective view of the apparatus retaining and storing either both halves of removable combination doors, or the whole door of hard windowed removable vehicle doors. The apparatus is shown removed from the vehicle tow hitch receiver for clarity.

FIG. 2 is a perspective view of the apparatus retaining and storing the upper halves of combination removable doors. The apparatus has been removed from the vehicle tow hitch receiver for clarity.

FIG. 3 shows the whole door and combination removable door configurations.

FIG. 4 is a perspective view of the apparatus in the upright position.

FIG. 5 is a perspective view of the apparatus in the upright position and from the opposite side from FIG. 4.

FIG. 6 is a perspective view of the apparatus in the folded position.

FIG. 7 is a perspective view of the apparatus in the folded position and from the opposite side from FIG. 6.

FIG. 8 is an exploded view of the hitch bar assembly showing the mechanism used to stabilize the apparatus in the vehicle tow hitch receiver. Also shown are the plates, shims, bolts and pin used to attach the hitch bar to the cross bar.

FIG. 9 is an exploded view of the latch post showing the adjustable bracket and adjustable “U” bolts used to retain the latch points of the removable vehicle doors. Also shown are the plates, shims, bolts, and pin used to attach the latch bar to the cross bar.

FIG. 10 is an exploded view of the hinge post showing the adjustable brackets used for retaining the hinge points of the removable vehicle doors. Also shown are the plates, shims, bolts, and pin used to attach the hinge bar to the cross bar.

FIG. 11 is an exploded view of the upper hinge bracket of the hinge post showing the adjustable mechanism.

FIG. 12 is an exploded view of the cross bar showing the adjustable brackets used for retaining the upper halves of removable combination doors. These brackets work in conjunction with the lower hinge bracket on the hinge post as shown in FIG. 13 to retain the upper halves of removable doors.

FIG. 13 is a perspective view of the upper half of removable combination doors as retained and stored by the apparatus. Components of the apparatus have been removed for clarity.

FIG. 14 is a detailed view of the latch points of the removable vehicle doors and their relationship to the apparatus.

FIG. 15 is a detailed view of the upper hinge points of the removable doors and their relationship to the apparatus.

FIG. 16 is a detailed view of the lower hinge points of the removable doors and their relationship to the apparatus.

### DETAILED DESCRIPTION OF THE PREFERRED EMBODIMENT

Reference will now be made in detail to the presently preferred embodiment of the invention as illustrated in the accompanying drawings. Each example is provided by way of the explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numbers are assigned to the same components throughout the drawings and description.

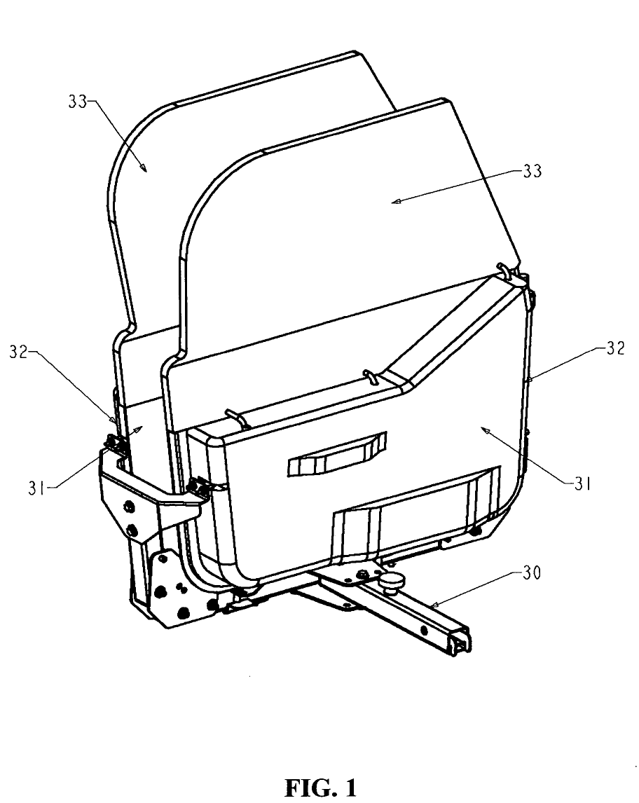

A presently preferred embodiment of the removable vehicle door retention and storage apparatus that can be easily inserted into a vehicle tow hitch receiver as shown in FIG. 1 is represented generally by the number 30. The embodiment shown for purposes of explaining the invention is for the trailer tow hitch of a Jeep vehicle with removable doors. However, the present invention can be provided for in other applications where other vehicles may have removable doors and a vehicle tow hitch.

As shown in FIG. 1, removable doors 31 can be easily retained and stored by an apparatus 30 that can be easily inserted into a vehicle tow hitch receiver as an aftermarket accessory. Removable doors 31 can be whole doors with hard windows, or be made as combination doors with lower half 32 and upper half 33.

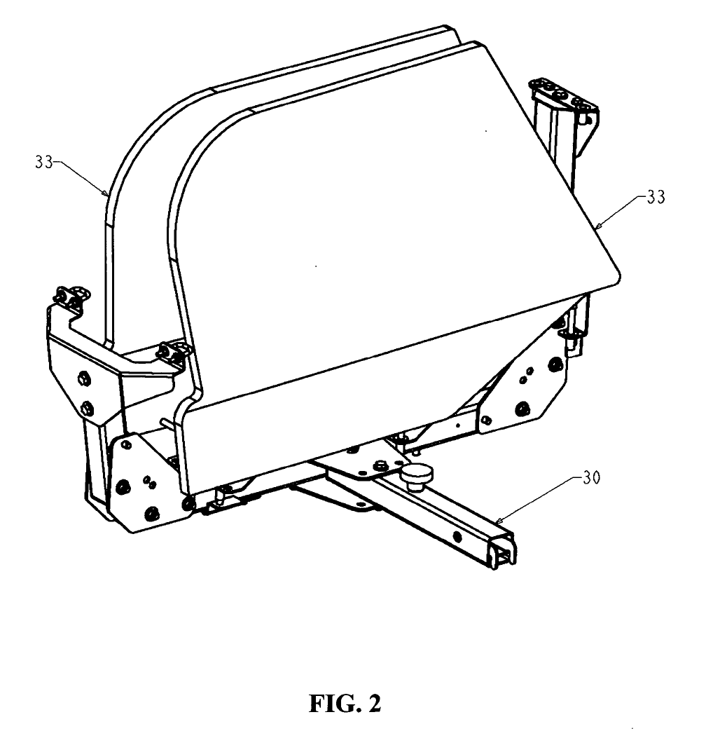

FIG. 2 shows the upper half of removable doors 33 retained and stored by an apparatus 30 that can be easily inserted in a vehicle tow hitch receiver as an aftermarket accessory.

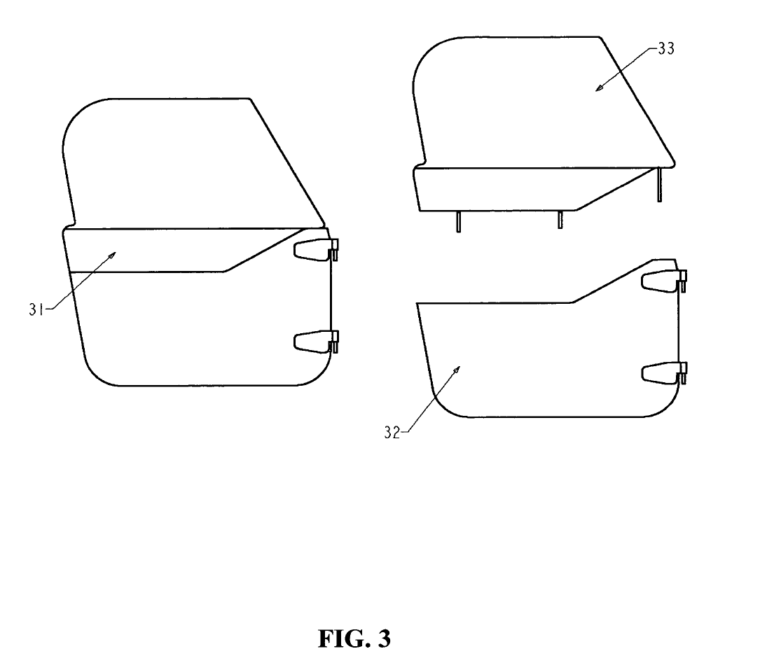

FIG. 3 shows the removable door 31, as either a whole door with hard windows, or a combination door with lower half 32 and upper half 33 assembled together. It also shows the combination door as disassembled with lower half 32 and a upper half 33.

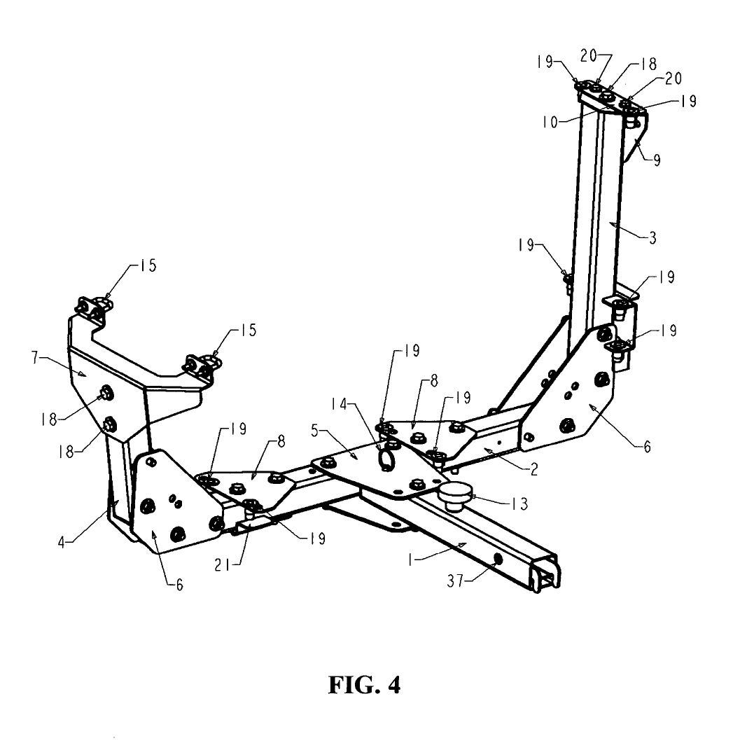

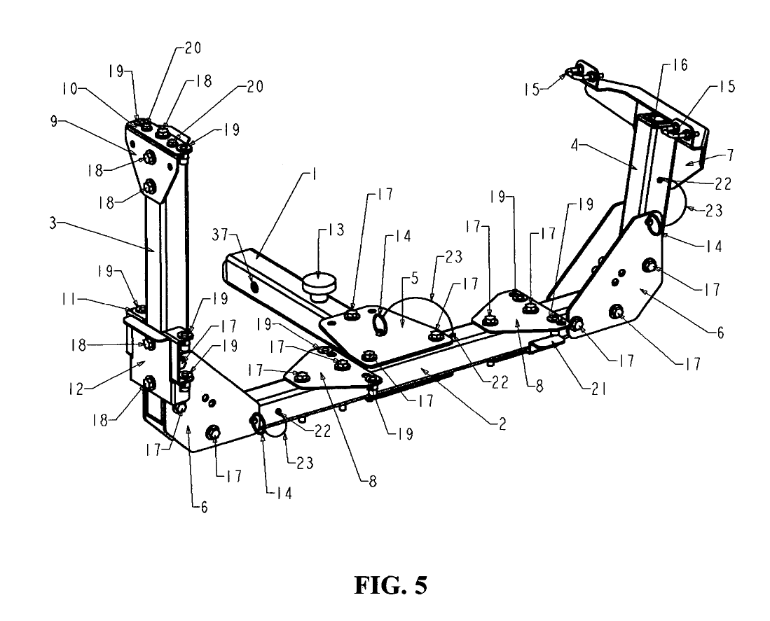

FIG. 4 and FIG. 5 show the assembly of the apparatus 30 from opposing views. The assembly starts with the hitch bar 1, which is inserted into the vehicle tow hitch receiver and retained by a standard clevis pin through a retention hole 37. The cross bar 2 is attached to the hitch bar 1 using bolts 17 and opposing plates 5. The hinge post 3 and latch post 4 are attached to the cross bar 2 using bolts 17 and opposing plates 6. Also attached to the cross bar 2 using bolts 17 are the half door brackets 8 and half door stop bracket 21. Attached to the hinge post 3 using bolts 18 are the upper hinge bracket 9, lower hinge bracket 11 and lower hinge half door stop bracket 12. The upper hinge adjuster bracket 10 is attached to the upper hinge bracket 9 using a bolt 18. This bolt 18 forms a pivot axis for the upper hinge adjuster bracket 10 which is clamped after adjustment by bolts 20. Attached to the latch post 4 using bolts 18 is the latch bracket 7. “U” bolts 15 are attached to the latch bracket 7 with adjustable hardware. A clevis pin 14 is used to lock the hitch bar 1, the hinge post 3, and the latch post 4 in either the upright or folded positions. The clevis pin 14 is tethered by a lanyard 23 which is fastened to the cross bar 2 and the latch post 4 by screws 22. Decorative plugs 16 are used to seal the open ends of the hitch bar 1, cross bar 2, hinge post 3, and latch post 4.

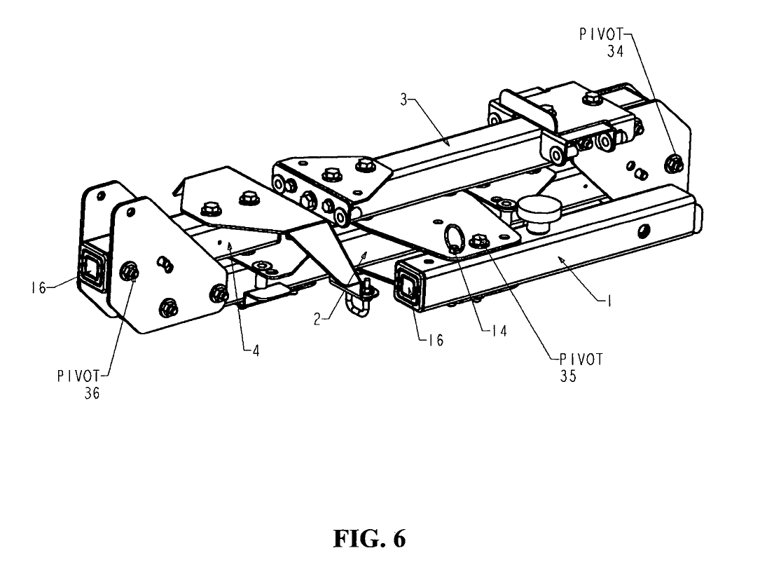

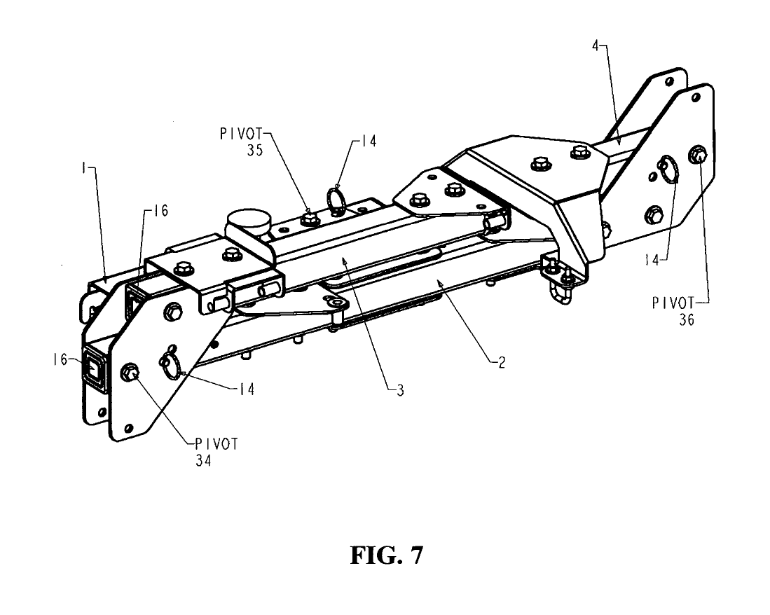

FIG. 6 and FIG. 7 show the folded assembly of the apparatus 30 from opposing views. The apparatus 30 has been folded at pivot points 34, 35 and 36 by removing the clevis pins 14 and re-inserting them in the folded position to secure the components.

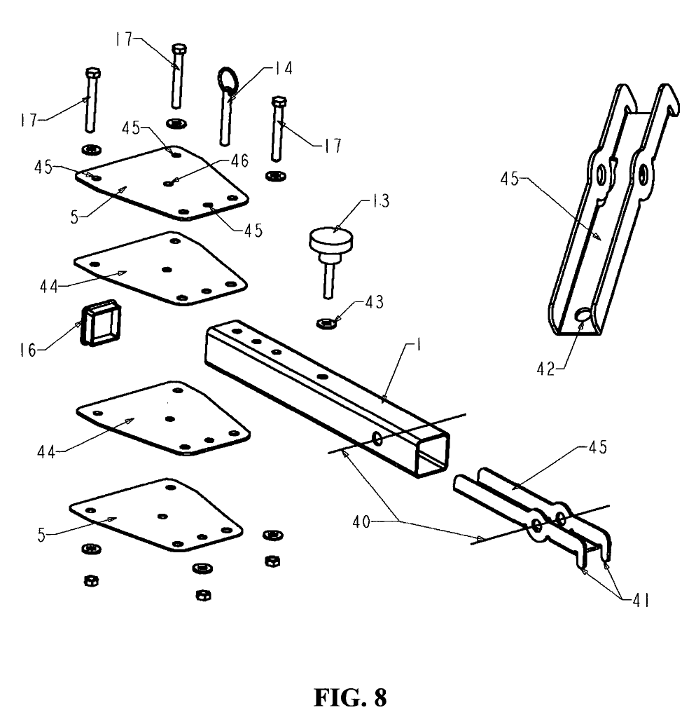

FIG. 8 shows an exploded view of the hitch bar assembly. Shown in this view is the hitch clamp 45 which stabilizes the apparatus 30 in the vehicle tow hitch receiver. The hitch clamp 45 is inserted into the hitch bar 1 and a clamping knob 13 is screwed into threaded insert 42 to retain the mechanism in the hitch bar 1. When the apparatus 30 is inserted into the vehicle tow hitch receiver, the standard clevis pin forms a pivot axis 40. By tightening the clamping knob 13, a force is transferred through the pivot axis 40 to the contact points 41, which stabilizes the apparatus 30 in the vehicle tow hitch receiver. A washer 43 is used under the clamping knob 13 to reduce friction and protect the surface finish. At the opposite end of the hitch bar 1 are the opposing plates 5 which are used for attachment to the cross bar 2. Upon assembly, shims 44 are inserted between the plates 5 and the hitch bar 1 and cross bar 2 to reduce friction and protect the surface finish. Bolts 17 are used to secure the opposing plates 5 to the hitch bar 1 and cross bar 2 thru holes 45. The clevis pin 14 inserts thru a hole 46 to prevent movement of the joint and allow for folding of the hitch bar 1 in alignment with the cross bar 2.

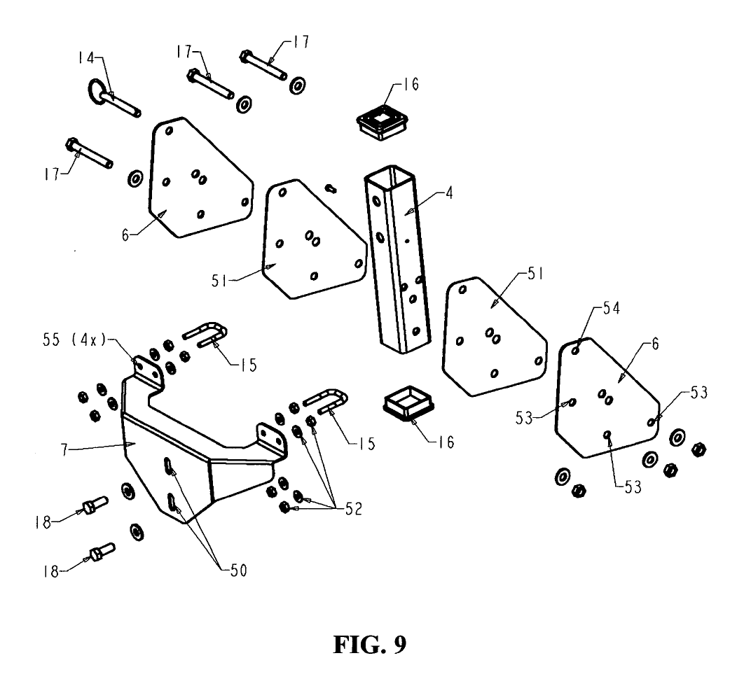

FIG. 9 shows an exploded view of the latch post assembly. At one end of the latch post 4 are the opposing plates 6 which are used for attachment to the cross bar 2. Upon assembly, shims 51 are inserted between the plates 6 and the latch post 4 and cross bar 2 to reduce friction and protect the surface finish. Bolts 17 are used to secure the opposing plates 6 to the latch post 4.and cross bar 2 thru holes 53. The clevis pin 14 inserts in a hole 54 to prevent movement of the joint and allow for folding of the latch post 4 in alignment with the cross bar 2. At the opposite end of the latch post 4 is the latch bracket 7, which contains slots for adjustment relative to the latch post 4. Attached to the latch bracket are “U” bolts 15 which are adjustable on the axis of their mounting holes 55 by use of opposing washers and nuts 52.

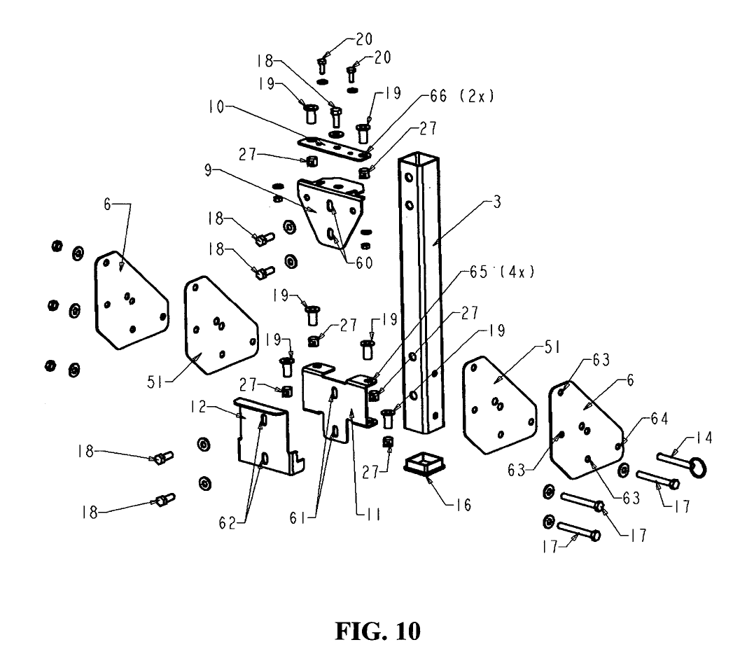

FIG. 10 shows an exploded view of the hinge post assembly. At one end of the hinge post 3 are the opposing plates 6 which are used for attachment to the cross bar 2. Upon assembly, shims 51 are inserted between the plates 6 and the hinge post 4 and cross bar 2 to reduce friction and protect the surface finish. Bolts 17 are used to secure the opposing plates 6 to the hinge post 4 and cross bar 2 thru holes 63. The clevis pin 14 inserts in a hole 64 to prevent movement of the joint and allow for folding of the hinge post 4 in alignment with the cross bar 2. At the same end of the latch post 4 is the lower hinge bracket 11. The lower hinge bracket 11 is sandwiched between the lower hinge bracket half door stop 12 when attached to the hinge post 3 using bolts 18. Slots 61 in the lower hinge bracket 11 and slots 62 in lower hinge bracket half door stop 12 allow for adjustment relative to the hinge post 3. Bushings 19 are inserted into the lower hinge bracket 11 in holes 65 (4x) and retained by spring clips 27 (4x). At the opposite end of the latch post is the upper hinge bracket 9 which is attached to the hinge post 3 by bolts 18. Slots 60 in the upper hinge bracket 9 allow for adjustment relative to the hinge post 3. The upper hinge adjuster bracket 10 is attached to the upper hinge bracket 9 by a bolt 18. This bolt 18 forms a pivot axis for the upper hinge adjustment bracket 10 which is clamped after adjustment by bolts 20. Bushings 19 are inserted into the upper hinge adjustment bracket 10 in holes 66 (2x) and retained by spring clips 27 (2x).

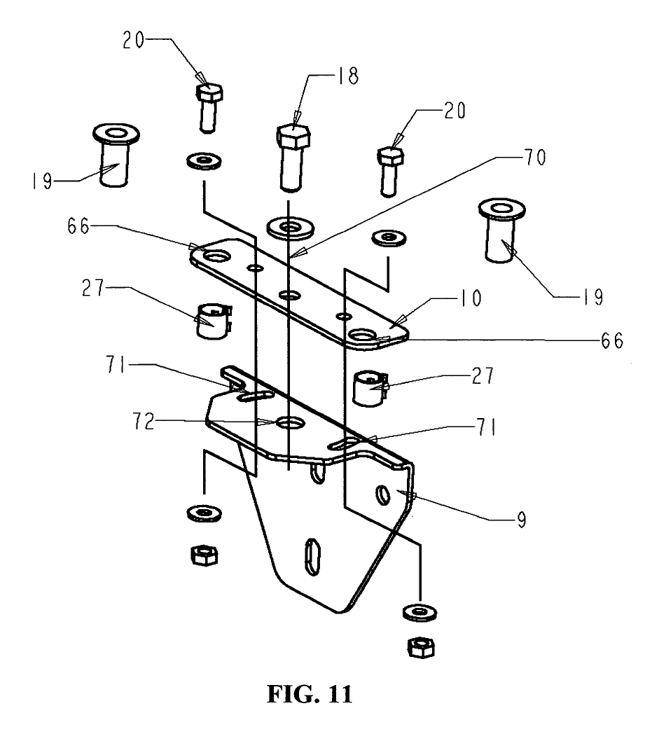

FIG. 11 shows an exploded view of the upper hinge adjustment bracket assembly. The upper hinge bracket contains a threaded insert in a hole 72, and when a bolt 18 is used to secure the upper hinge adjustment bracket 10 to the upper hinge bracket 9, an axis of rotation 70 is formed. When the removable door hinge pins are inserted into the bushings 19 that are retained by the upper hinge adjustment bracket 10, the bracket rotates about the axis 70 so the latch points at the rear of the removable doors can be aligned. Slots 71 in the upper hinge bracket 9 allow for rotation of the locking bolts 20 relative to the rotation axis 70 during the alignment. This alignment allows for the balanced adjustment of the latch bracket 7 in FIG. 9. Once the latch points are aligned, the locking bolts 20 are tightened to clamp the upper hinge adjustment bracket 10 to the upper hinge bracket 9 preventing further movement about the rotation axis 70. The axis bolt 18 can then be tightened to provide further clamping action. Bushings 19 are inserted into the upper hinge adjustment bracket 10 in holes 66 (2x) and retained by spring clips 27 (2x).

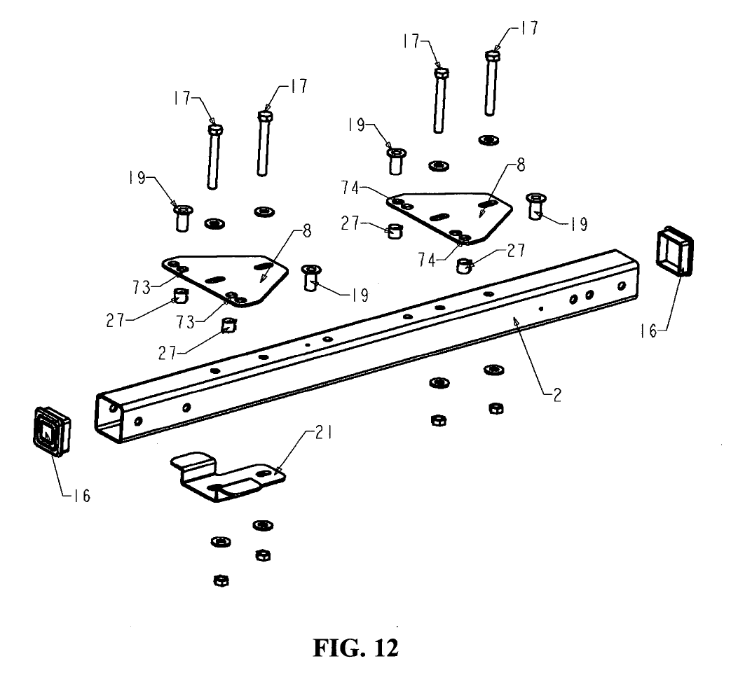

FIG. 12 shows an exploded view of part of the cross bar assembly. Close to one end of the cross bar 2 is the rear half door bracket 8, which is attached to the cross bar 2 by bolts 17. The half door stop bracket 21 is simultaneously attached the opposite side of the cross bar 2 by bolts 17. Bushings 19 are inserted into the half door bracket 8 in holes 73 (2x) and retained by spring clips 27 (2x). At the opposite end of the cross bar 2 is the mid point half door bracket 8, which is attached to the cross bar 2 by bolts 17. Bushings 19 are inserted into the half door bracket 8 in holes 74 (2x) and retained by spring clips 27 (2x).

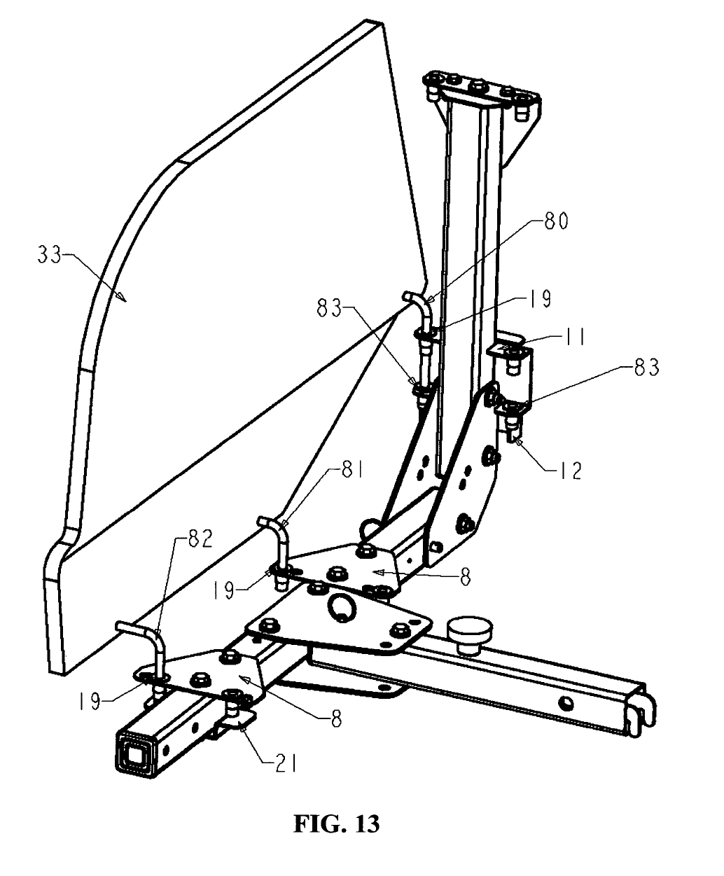

FIG. 13 shows the retention and storage of the upper half 33 of a combination removable door by the apparatus 30. The front pin 80 of the upper half door 33 is retained by a bushing 19 in the lower hinge bracket 11. The lower hinge half door stop bracket 12 stops the pin 80 from inserting too far. The lower hinge bracket 11 has two lower bushings 19 in holes 83 that stabilize the half door pin 80. The mid point pin 81 of the half door 33 is retained by a bushing 19 in a half door bracket 8. The rear pin 82 of the half door 33 is also retained by a bushing 19 in a half door bracket 8. The half door stop bracket 21 stops the rear pin 82 from inserting too far. These three pins, front 81, mid 82, and rear 83 are retained simultaneously by the apparatus 30 to stabilize the upper half door 33.

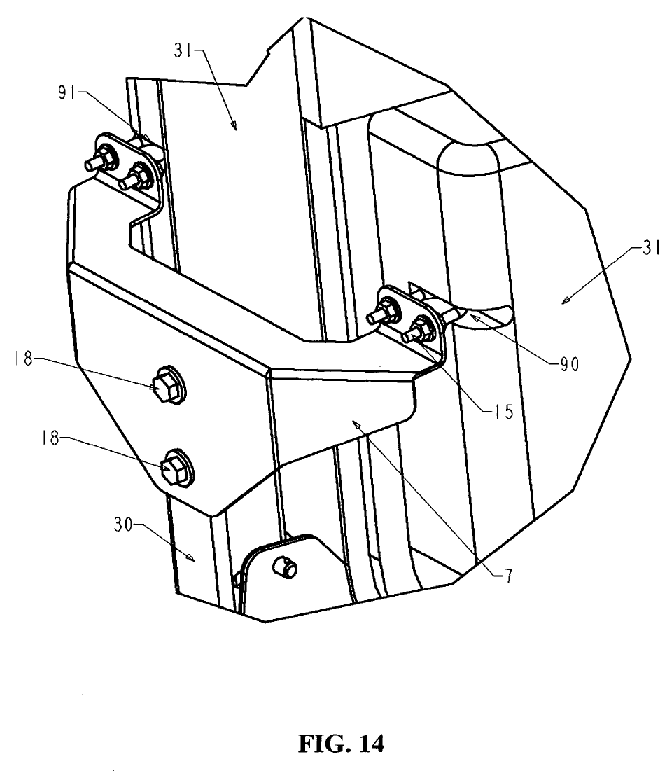

FIG. 14 shows a detailed view of the latch points 90 and 91 of the removable doors 31. After proper adjustment of the latch points 90 and 91 as outlined in FIG. 11, the latch bracket 7 and “U” bolts 15 can be adjusted for proper latching.

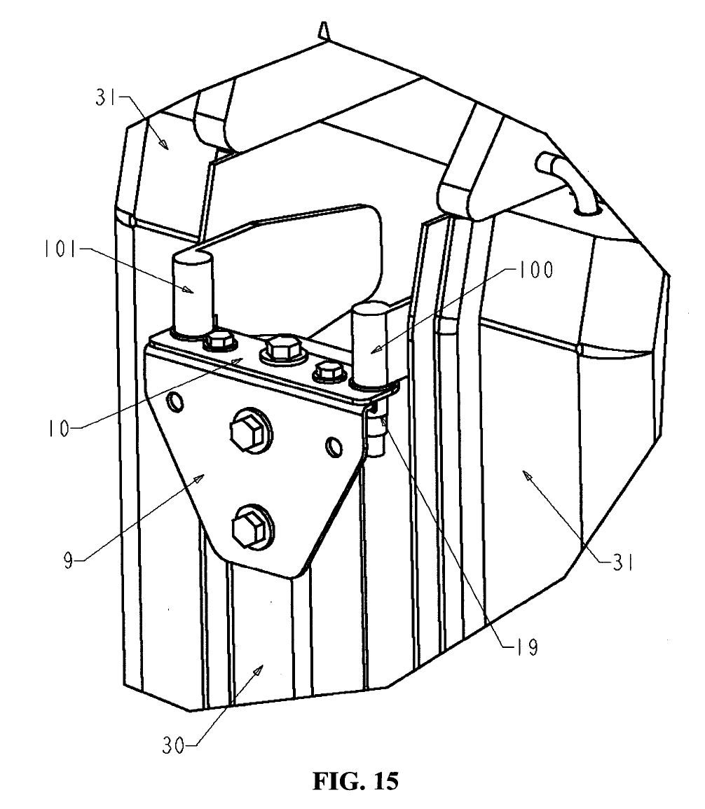

FIG. 15 shows a detailed view of the removable doors 31 as retained by the upper hinge adjustment bracket 10. Hinge pins 100 and 101 are retained by bushings 19.

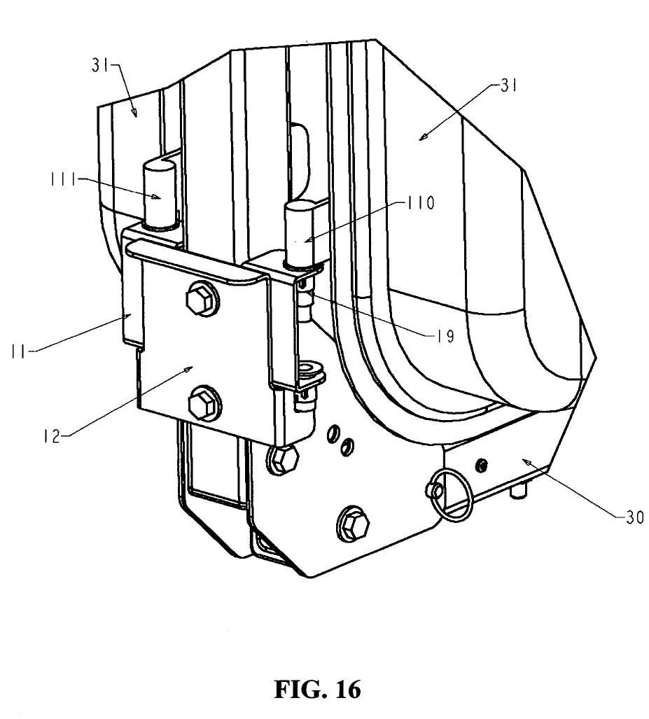

FIG. 16 shows a detailed view of the removable doors 31 as retained by the lower hinge bracket 11. Hinge pins 110 and 111 are retained by bushings 19.

While at lease one presently preferred embodiment of the invention has been described using specific terms, such description is for illustrative purposes only, and it is to be understood that changes and variations may be made without departing from the spirit or scope of the following claims.

What is claimed is:

1. An apparatus that provides for retention and storage of removable vehicle doors and that can be easily inserted into a vehicle tow hitch receiver as an aftermarket accessory, the apparatus comprising:
a structure consisting of a hitch bar, cross bar, hinge post and latch post;
a series of adjustable retention brackets fastened to the structure; and
a series of plates holding the structure together that allow the structure to fold.

2. An apparatus as in claim 1, where the apparatus folds into a low profile position while inserted into the vehicle tow hitch receiver.

3. An apparatus as in claim 1, where the apparatus when removed from the vehicle tow hitch receiver can be folded into a low profile position for storage behind the vehicles rear seat.

4. An apparatus as in claim 1, where the apparatus retains and stores the upper and/or lower removable doors of combination type doors.

5. An apparatus as in claim 1, where the apparatus retains and stores the removable hard windowed type doors.

6. An apparatus as in claim 1, where the hitch bar is easily retained and removed from the vehicle tow hitch receiver by use of a standard clevis pin.

7. An apparatus as in claim 1, where a mechanism is housed inside the hitch bar to stabilize the apparatus in the vehicle tow hitch receiver.

8. An apparatus as in claim 1, where the cross bar is attached to the hitch bar with plates that allow for folding.

9. An apparatus as in claim 1, where the hinge post is attached to the cross bar with plates that allow for folding.

10. An apparatus as in claim 1, where the latch post is attached to the cross bar with plates that allow for folding.

11. An apparatus as in claim 1, where adjustable brackets allow for the retention of removable vehicle doors by their hinge pins.

12. An apparatus as in claim 1, where adjustable brackets allow for the alignment of the removable door latch points.

13. An apparatus as in claim 1, where adjustable brackets allow for the retention of removable vehicle doors by their latch points.

14. An apparatus as in claim 1, where adjustable brackets allow for retention of the upper half of removable combination doors.

15. An apparatus as in claim 1, where the adjustable brackets have bushings to retain and prevent damage to the removable door pins.
